(19) United States
(12) Patent Application Publication
(10) Pub. No.: US 2004/0119374 A1
(43) Pub. Date: Jun. 24, 2004

(54) Axial flux induction motor

(76) Inventors: Ralph James Carl JR., Clifton Park, NY (US); Charles Michael Stephens, Pattersonville, NY (US)

Correspondence Address: GENERAL ELECTRIC COMPANY (PCPI), C/O FLETCHER YODER, P.O. BOX 692289, HOUSTON, TX, 77269-2289, US

(21) Appl. No.: 10/321,014

(22) Filed: Dec. 18, 2002

(51) Int. Cl. H02K 17/16; H02K 17/22

(52) U.S. Cl. 310/268; 310/211

(57) ABSTRACT

An axial flux induction motor containing both laminates and soft magnetic composite materials is described. By combining these two materials, the axial flux induction motor obtains a limited volumetric space, including a limited height, and smooth torque output, including a limited ripple. The axial flux induction motor also contains rotors bars that are skewed. These skewed bars smooth the torque pulsations of the induction motor, enhancing an efficient operation of the motor.

### BACKGROUND OF THE INVENTION

This invention generally relates to induction motors. In particular, this invention relates to axial flux inductor motors and methods for making such motors. Even more particularly, this invention relates to axial flux inductor motors made with soft magnetic composite materials.

Induction motors are motors that operate by an electromagnetic attraction between portions of the motors that produces a torque. The current within the stator causes an “induced” current to flow through conducting bars in the rotor. A force is created by the interaction of the magnetic fields created by the stator currents and the rotor currents. This force causes the rotor to rotate as it continually “chases” the magnetic field.

There are several topologies of induction motors. Radial flux induction motors are one of the most popular types because of their low cost and high reliability. Radial induction motors, however, tend to be relatively long in the axial dimension. As well, a large fraction of the height of a radial induction motor is attributed to the end turns of the windings.

Another topology of induction motor is the axial flux (AF) induction motor. One example of an AF induction motor is depicted in FIG. 8. In FIG. 8, an axial flux induction motor 30 contains a stator 10 having an iron core 11 and an electrical winding 13 arranged in a slot 12. A rotor 14 is spaced from the stator 10 by an air gap 15 and is rotatably supported on a shaft 16, and axially supported by a thrust bearing (not shown). Axial flux motors with a single shaft can be made with one or two rotors. The axial forces in a two rotor configuration are smaller because the forces on each rotor tend to balance each other. The invention is described in the context of a single rotor device, but the concepts could apply to a double rotor device. The direction of rotation for the rotor is indicated by 17. The rotor 14 contains a conductive layer 18 facing the stator 10 and a magnetically conductive layer 19 remote from the stator. The magnetically conductive layer 19, also referred to as the yoke of the rotor, can be either a solid layer, a laminated structure, or an assembly of a plurality of parts. The electrical winding 13 generates the magnetic field in the induction motor. In the case of multi-phase motors, this magnetic field is a rotary field, i.e. the maximum of the magnetic field strength rotates in the desired direction of rotation of the rotor 14 at the radial surface of the stator. See also, for example, the description in U.S. Pat. No. 5,763,975.

An AF induction motor has several advantages over the radial induction motor. First, the AF induction motor does not have end turns located in an area where the end turns contribute to the height of the motor. Second, the AF induction motor offers the potential for higher energy densities relative to a radial design. Third, the low axial profile of an axial flux induction motor allows this type of motor to be used where axial height and size are crucial elements, i.e., pumps, axial fans, wheel motors, etc. For example, forming an axial flux rotor such that it has the shape of an impeller enables a pump with a low profile in the axial direction to be created.

Most induction motors are constructed using materials in the yoke of the motor that minimize the losses due to eddy currents and hysteresis in order to produce an efficient motor. For example, conventional AF induction motors are made of laminate materials, often formed from steel. The laminations are shaped to try and keep the laminate direction in the same direction as the desired flux pattern. These laminated sheets are also used to help reduce the eddy currents in the magnetic flux path. Unfortunately, while these laminates have high relative permeability, they cannot be used to steer flux in three dimensions.

Soft magnetic composites (SMCs) are an alternative material to be used as a magnetic yoke. Soft magnetic composite materials can be used to steer magnetic flux in three dimensions, but typically have lower relative permeability than laminated structures. Thus, they have often been considered-but not often used-as a replacement of laminates in induction motors for several reasons. First, while the resistivity of the SMC can inhibit the formation of eddy currents that decrease the flux transport through the yoke, there is an unfortunate decrease in flux penetration observed across large cross-sectional areas. This reduction in effective permeability with respect to that measured in small a cross-sectional area is especially evident in some induction motors (e.g., those with pole counts less than 4). Second, SMCs structures often require a very high compaction force, thereby increasing the difficulty and complexity of the manufacturing process for making the induction motor.

### BRIEF SUMMARY OF THE INVENTION

The invention provides an axial flux induction motor containing both laminates and soft magnetic composite materials. By combining these two materials, the axial flux induction motor obtains a limited volumetric space, including a limited height. The axial flux induction motor also contains rotor bars that are skewed. These skewed bars smooth the torque pulsations of the induction motor, enhancing an efficient operation of the motor.

The invention includes an axial flux induction motor containing a stator containing a soft magnetic composite material and a rotor. The invention also includes an axial flux induction motor comprising a stator and a rotor containing a soft magnetic composite material. The invention further includes an axial flux induction motor comprising a stator and a rotor containing bars that are skewed. The invention still further includes an axial flux induction motor having an axial height less than about 3 cm. The invention encompasses a rotor for an axial flux induction motor, the rotor containing bars having a skew. The invention also encompasses an electrical machine containing an axial flux induction motor having a height less than about 3 cm.

The invention also includes a method for making an axial flux induction motor by providing a stator containing a soft magnetic composite material, providing a rotor, and combining the rotor and stator. The invention also includes a method for making an axial flux induction motor by providing a stator, providing a rotor containing a soft magnetic composite material, and combining the rotor and stator. The invention further includes a method for making an axial flux induction motor by providing a stator, providing a rotor containing bars which are skewed, and combining the rotor and stator. The invention still further includes a method for making a stator for an axial flux induction motor by combining a laminate material, pre-wound winding structures, and a soft magnetic composite material in a mold and then compacting the mold to make a stator. The invention encompasses a method for making a rotor for an axial flux induction motor by combining a laminate material and a soft magnetic composite material in a mold and then compacting the mold to make a rotor. The invention also encompasses a method for making an axial flux induction motor by providing a stator by combining a laminate material and a soft magnetic composite material in a mold and then compacting the mold, providing a rotor, and then combining the stator and the rotor. The invention further encompasses a method for making an axial flux induction motor by providing a stator, providing a rotor by combining a laminate material and a soft magnetic composite material in a mold and then compacting the mold, and then combining the stator and the rotor. The invention still further encompasses a method for making an axial flux induction motor by providing a stator, providing a rotor containing bars that are skewed;, and then combining the stator and the rotor.

### BRIEF DESCRIPTION OF THE DRAWINGS

FIGS. 1-8 are views of several aspects of an axial flux induction motor and methods for making and using the same according to the invention, in which:

FIG. 1 shows a cut-away side view of an axial flux induction motor in one aspect of the invention;

FIG. 2 shows a top view of a stator for an axial flux induction motor in one aspect of the invention;

FIG. 3 shows a top view of a rotor for an axial flux induction motor in one aspect of the invention;

FIG. 4 shows a partial view of a rotor and graphical representation of those elements used to determine rotor bar trajectory for use in an axial flux induction motor in one aspect of the invention;

FIG. 5 is a flowchart illustrating a method of making a stator for an axial flux induction motor in one aspect of the invention;

FIG. 6 is a flowchart illustrating a method of making a rotor for an axial flux induction motor in one aspect of the invention;

FIG. 7 shows side view of a stator for an axial flux induction motor in another aspect of the invention; and

FIG. 8 depicts a conventional axial flux induction motor.

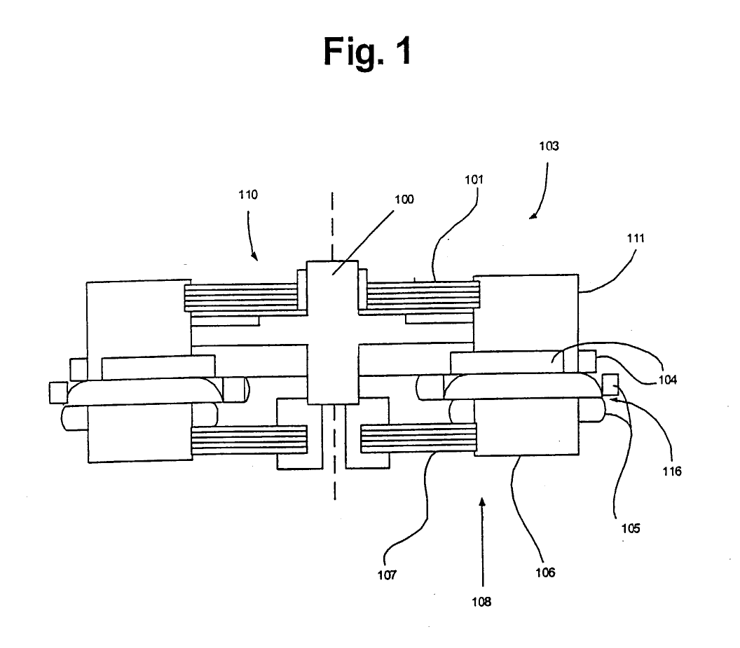

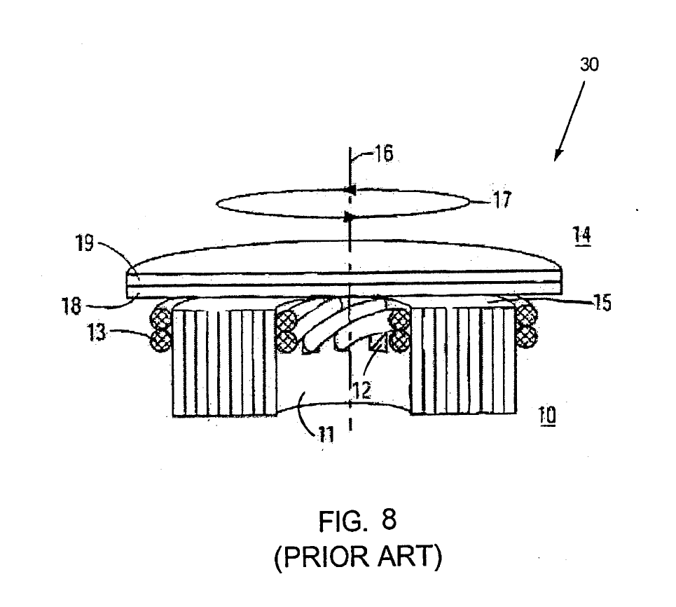

FIGS. 1-8 illustrate specific aspects of the invention and are a part of the specification. Together with the following description, the Figures demonstrate and explain the principles of the invention and are views of only particular, rather than complete, portions of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the present invention can be practiced by modifying the illustrated system and method and can be used in conjunction with apparatus and techniques conventionally used in the industry. For example, while the invention is described for an axial flux (AF) induction motor, the principles of the invention could be applied for other types of induction motors, including radial flux induction motors and linear induction motors.

As noted above, the invention generally comprises an axial flux induction motor with a limited volumetric space, including a limited height, and smooth torque output, including a limited torque ripple. Examples of such an AF induction motor is described below and depicted in FIGS. 1-8.

FIG. 1 illustrates a side view of an axial flux induction motor (110) in one aspect of the invention. The AF induction motor (110) contains two major components, the rotor (103) and the stator (108), as well as other necessary components as known in the art. As described above, the rotor and the stator work in combination to produce the torque required of the motor.

The rotor (103) is centered around and connected to a shaft or stud (100). Therefore, the rotation of the rotor is also centered about shaft (100) and drives the rotation of the shaft (100). In many applications the rotor is an integral part of the device and a shaft is not required to transmit the torque. For example the rotor may serve as an impeller for a pump. The rotor (103) can be connected to the shaft (100) using any means known in that art, such as overmolding, pressing, etc.

The rotor (103) is a molded body containing a (101), a “cage”, (104) soft magnetic composite teeth, and in some aspects, a laminated stack in the area where flux transport is planar (111). As noted below, the rotor teeth (111) contain a soft magnetic composite (SMC) material that provides numerous advantages. In combination with the laminate structure (101), the cage (104) and the rotor teeth (111) exhibit the electrical and magnetic properties needed for the rotor (103) to function. Because the frequency of the magnetic field in the rotor is not as high as in the stator, the skin depth of SMC materials in the rotor need not be as great. Thus, the measures taken to improve the effective permeability in the SMC material in the rotor are often not required.

The rotor (103) rotates supported in axial and radial directions by any suitable means known in the art. Examples of such means include roller bearings, sintered brass bearings, ceramic bushings, or combinations thereof.

The motor (110) also contains a stator (108). The stator (108) is stationary. The stator (108) contains a plurality of windings (105), soft magnetic composite teeth, and a laminated structure placed where flux transport is essentially planar. The plurality of windings is typically made of an insulated conducting material such as insulated copper wires. Using highly compacted windings minimizes the length of the motor in the axial direction.

In one aspect of the invention, the plurality of windings can contain both a main winding and an auxiliary winding. When AC current flows through the windings, the windings (105) generate a magneto motive force in the induction motor. In one aspect of the invention (e.g., multi-phase motors), this field is a rotary field, i.e. the maximum of the magnetic field strength rotates in the desired direction of the rotation of the rotor at the surface of the stator. This field produces currents in the rotor conductors (103), which interact with the magnetic field to drive the rotor in the direction of rotation of the field.

The stator (108) also contains teeth (106) and an embedded laminate structure (107). The laminate structure (107) can be formed of any high permeability magnetic material in the form of laminates or sheets. In one aspect of the invention, the lamination stack is made of electrical steel laminates stacked together into the desired shape. As noted below, the stator teeth (106) contain a SMC material that provides numerous advantages. The stator teeth convey flux from the stator (108) to the rotor (103) through a low reluctance path.

The combination of the laminate structure (107) and molded SMC material for the teeth (106) provide several advantages to the motor (110). First, this combination allows the magnetic flux to flow through the laminate structure (107) and then via the three-dimensional capabilities of the SMC material into a rotor (103). Second, this combination allows the motor (110) to be reduced in size while still maintaining performance and power output. Third the use of the laminated structure embedded in the soft magnetic composite allows magnetic flux to penetrate deeper into the yoke structure than if the laminate were replaced with soft magnetic composite material.

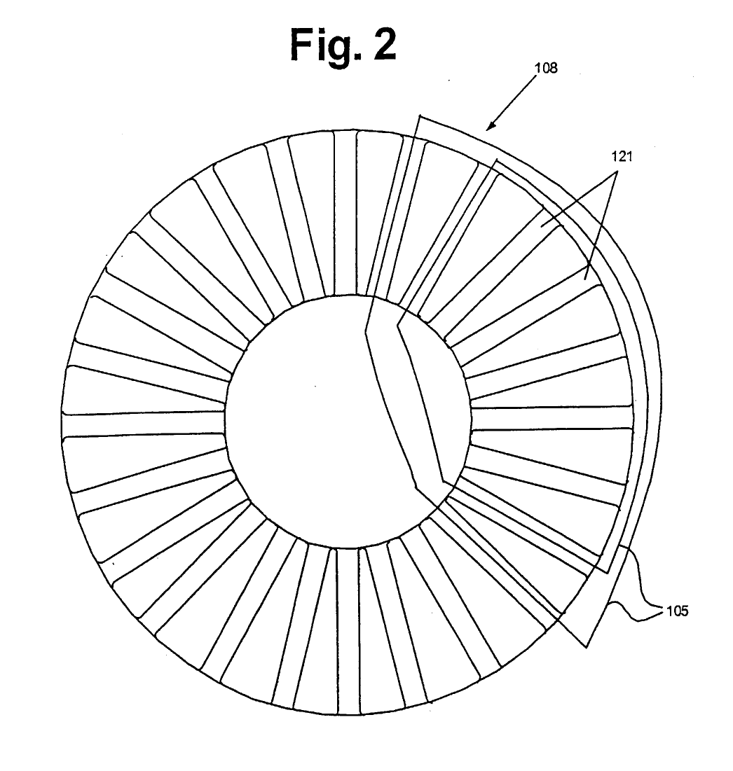

FIG. 2 depicts a detailed, top-view of the stator (108). One of the purposes of the stator (108) is to create a spatially and temporally varying magnetic field in the air gap between the rotor and stator. The magnetic field is produced by windings embedded in slots in the stator. In one aspect of the invention, the percentage of the slots (121) filled with copper conduction elements or windings can range from about 34% to about 70%. In another aspect of the invention, this percentage can range from about 50% to about 70%. To further limit the axial length of the motor the windings may be distributed such that there is only one winding per slot per phase.

This high copper fill factor percentage in the slots can be achieved by using two techniques. In the first technique, and as described in more detail below, the SMC powder can be compacted around a pre-wound winding structure. Using highly compacted windings can minimize the length of the motor in the axial direction. In the second technique, the pre-wound winding structure and SMC powder can be compacted prior to the stator assembly and then pressed into the molded stator slots. Utilizing SMC materials in the stator teeth reduces the reluctance of the magnetic circuit compared to a slot less machine design.

The stator (108) also contains an embedded laminate (107) as shown in FIG. 1. The embedded lamination can be very effective in conducting magnetic flux in two dimensions. Therefore, this embedded laminate is most advantageously used where the current path is two-dimensional. Using a laminated structure in such a position as shown in FIG. 1 overcomes the flux penetration problem often found with large soft magnetic structures.

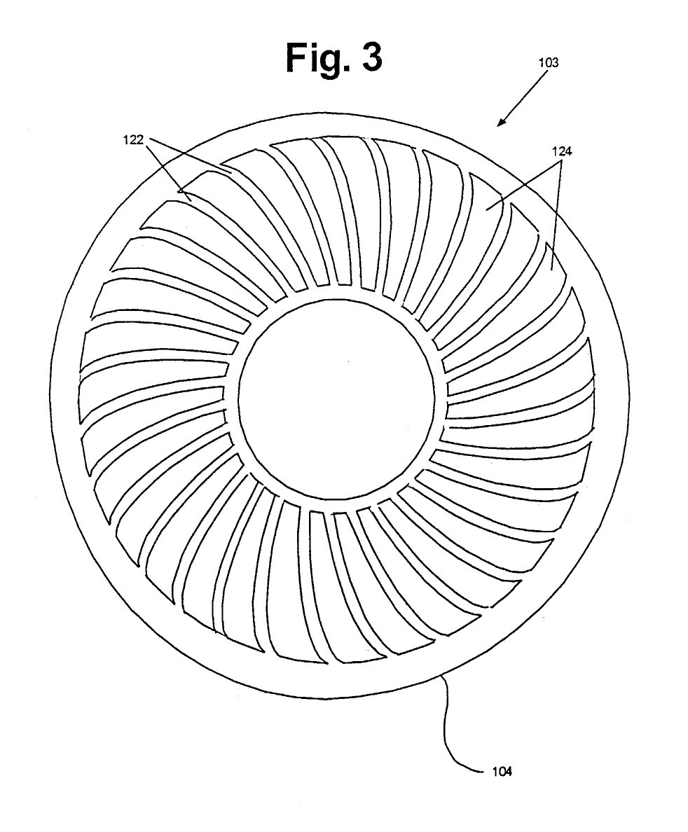

FIG. 3 illustrates a top view of a rotor (103) for the axial flux induction motor illustrated in FIG. 1. As shown in FIG. 3, the rotor bars (124) are shaped so as to introduce a skew. Skewed rotor slots are known in radial induction motors. Rotor bars are typically die cast into holes in a stack of laminations that form the yoke for the radial machine rotor. Such holes are typically skewed by stacking the laminations so that each hole in a lamination is rotated slightly relative to the previous lamination. The conducting cage is formed in the cavity created by pre-punched holes in individual laminations. The purpose of skewing the rotor cage is to minimize flux linkage variations in the windings as the rotor cage travel transverses a stator slot pitch. This in turn reduces torque ripple, noise, and high frequency harmonics in the voltage waveform. In a radial machine the skew typically forms a helix spanning one stator slot pitch (the stator slot pitch is the angular displacement between adjacent slots of the stator).

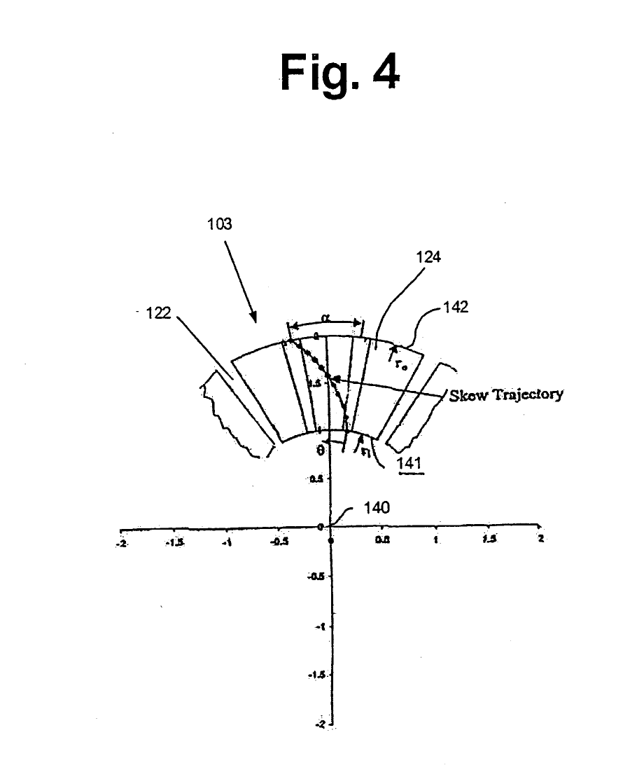

The invention has taken this concept of skewed rotor slots and used them in AF induction motors. Such a rotor would have a structure as depicted in FIG. 3. FIG. 4 shows a partial view of a rotor (103) with skew trajectory of the center line of the rotor bars (122), as well as a graphical representation of how the rotor trajectory is determined for such a rotor. In one aspect of the invention, the trajectory typically spans one stator slot pitch for a split phase motor.

Without being limited by this explanation, it is believed that the optimal skew trajectory can be determined in the following manner. This optimal skew is defined such to be equivalent to the effective skew produced by helical rotor bars in a radial machine. By assuming that the stator slots (122) follow lines of constant angle, the proportion of the skew pitch area enclosed by θ can be expressed in relation to α as:

$$\frac{θ}{α} \cdot {A}_{α} = \frac{α}{2} ( {r ( θ )}^{2} - {r}_{i}^{2} ) ;$$

where rᵢ represents the radius between a center point (140) of the stator and an inner surface (141), α represents a pitch angle between the substantially uniform stator slot pitch intervals, and A_{α} represents the skew pitch area as:

$${A}_{α} = \frac{α}{2} ( {r}_{o}^{2} - {r}_{i}^{2} ) ,$$

where rₒ represents the radius between the center point and an outer surface (142). Thus, the radial trajectory coordinate r corresponding to the peripheral trajectory coordinate θ for the rotor bar can be determined as follows:

$$r ( θ ) = \sqrt{{r}_{o}^{2} \cdot \frac{θ}{α} + {r}_{i}^{2} \cdot ( 1 - \frac{θ}{α} )} \qquad for 0 \leq θ \leq α .$$

The AF induction motor (110) of the invention can be made in any suitable manner known in the art that will provide the motor with the desired properties mentioned above. In one aspect of the invention, the rotor and the stator are made separately and then combined with the other components of the motor as known in the art to make the AF induction motor.

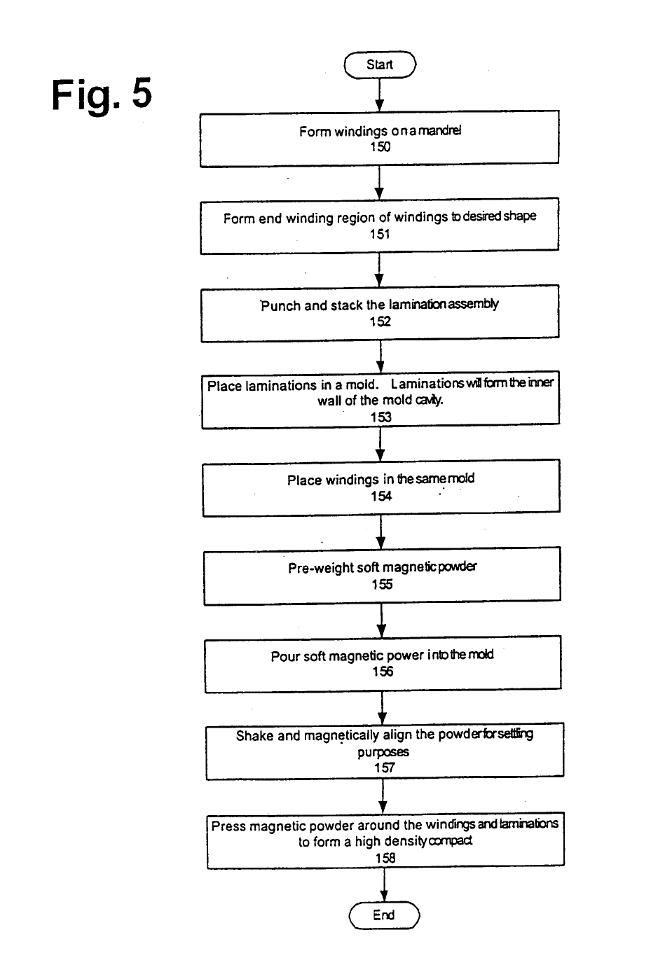

The stator (108) can be made using any process that will provide the stator with the properties described above. One example of such a process is described below and illustrated in FIG. 5. In this process, the desired number of electrical coils (commonly copper) is determined and then wound on a mandrel (150) in bunches. The bunches contain the necessary number of windings (105). The end windings may then be formed into the desired shape (151) with substantial coil excess to reach between poles.

The laminate material is selected and the lamination assembly is then punched and stacked (152). The laminations are then placed in a mold (153). These laminations form the innermost wall of the mold cavity. The windings previously formed (150) are then placed in the same mold (154). The necessary amount of SMC powder is then determined and weighed (155), and then poured into a mold (156). The amount of SMC powder depends on the size of the motor and the properties needed for the stator.

The mold containing the lamination assembly, windings, and SMC powder may then be shaken (157). This step may be performed using a vibration table, air jet, electromagnetic excitation or other means that allow the powder settle within the mold, allow air pockets to be reduced and ensure high density in the interface region between the powder and the components to be embedded. The resulting structure is then compacted with applied pressure to form a high density compact (158). Because a laminated structure is used in lieu of soft magnetic composite powder, the force required to create the structure is less than if the entire structure were created from soft magnetic composite powder. Hence the capital equipment and process required to achieve the compaction is less costly.

In one aspect of the invention, the SMC powder can be molded around embedded components that serve as current conductors. The SMC powder can also be also molded around an assembly of laminations. The lamination assembly may be flat as shown in FIG. 1. These laminations have a higher level of saturation and higher permeability than the SMC materials. Thus, strategic use of laminations embedded in the SMC material enables the induction motor to be smaller. Furthermore, the use of a laminated structure embedded in a soft magnetic composite structure improves the ability of flux to penetrate into the core of the machine. While soft magnetic composites consist of particles that are substantially electrically isolated from each other, eddy currents that limit flux penetration in large structures made with SMC's are still observed. Properly sized embedded lamination stacks enable more complete flux penetration.

In one aspect, the invention enables motors with small pole counts to be made by inserting laminations or other eddy current breakers/blockers in areas where such eddy currents will limit flux penetration. The embedded laminate structure contacts the SMC material, thereby enabling flux to pass from the two mediums.

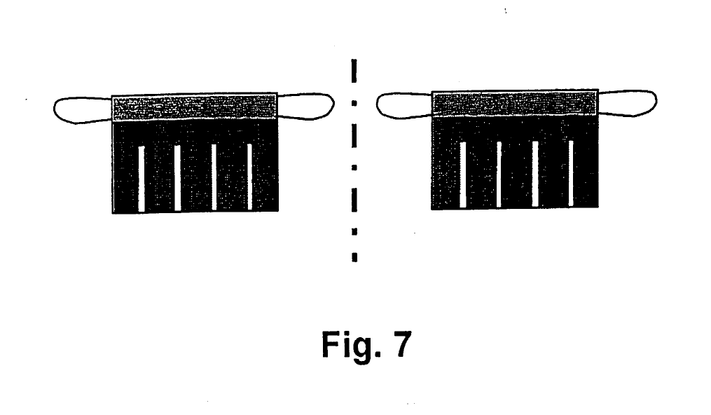

In addition to using embedded laminations to enhance flux penetration into the core, the soft magnetic composite material may be molded with slots or gaps such that eddy currents are limited. Indeed one example of eddy current breakers is the stator slots that contain the winding structure. Another example is the solid SMC structure shown in FIG. 7 where eddy current grooves can be molded directly into the stator. In FIG. 7 the grooves serve to prevent the build up of eddy currents that would limit flux penetration. Grooves could be used in lieu or in addition to embedded laminated structures.

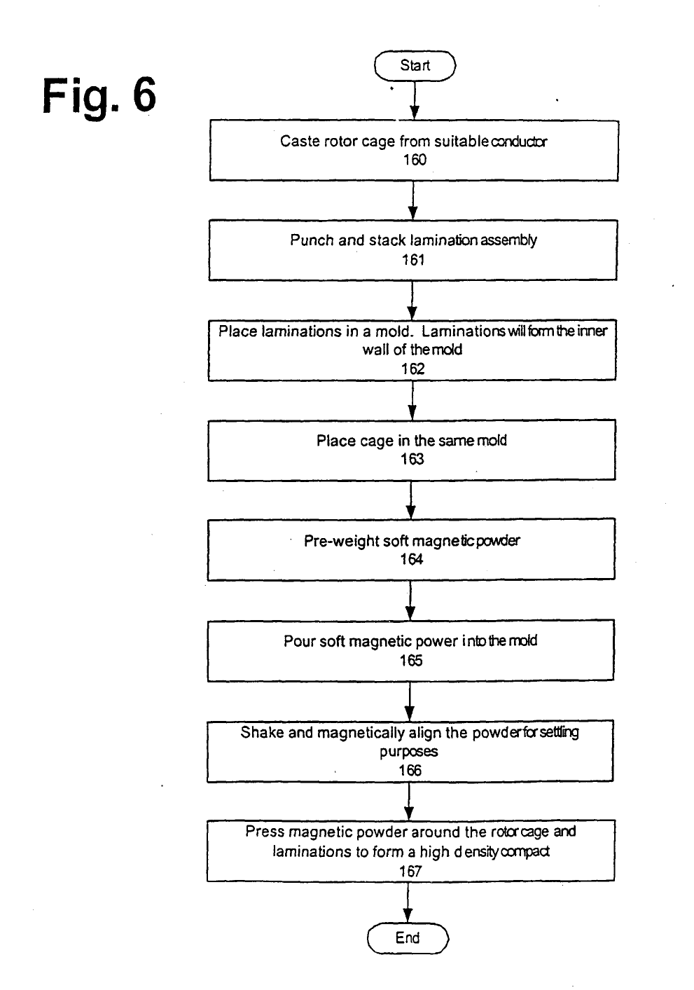

The rotor (103) can be made using any process that will provide the rotor with the properties described above. One example of such a process is described below and illustrated in FIG. 6. The process for making the rotor begins by casting the rotor cage from a suitable conducting material (160). Suitable conducting materials include those that are electrically conducting, exhibit the necessary structural strength, and thermal stability. Examples of conducting materials include copper, and aluminum, and their alloys. In one aspect of the invention, the rotor cage is die cast from aluminum. The rotor bars are cast to the final net shape including the skew in the radial bars.

A lamination assembly may then be punched and stacked (161) and then placed in a mold (162). The laminations may form one of the walls of the mold cavity. The rotor cage previously formed (160) is then placed in the same mold (163). A motor specific amount of SMC powder may then be pre-weighed (164) and then poured into the mold (165).

The mold and injected powder are then shaken for settling purposes (166). This may be done using a vibration table, air jet, electromagnetic excitation or other means that allow the powder to settle in the mold. The resulting structure may then be compaction molded to obtain the rotor.

To make the AF induction motor, the rotor and the stator are the combined with the other components of the motor (such as the shaft) as known in the art.

Using the above method and materials, an AF induction motor is obtained with an increased energy density and decreased height in the axial direction compared to radial flux induction motors. Conventional radial flux inductions motors with a shaft output of approximately 100 Watts require a height of about 6 cm. Using the above methods and materials, the height of comparable axial motors of the invention can be less than about 3 cm. In one aspect of the invention, this height can range from about 2 cm to about 3 cm

The AF induction motors of the invention can be used in numerous types of electrical machines. For example, they can be used as seal less pump motors in, for example, dishwasher pumps and sump pumps. They can also be used as wheel motors in, for example, electric bikes, golf carts, and small cars. They can even be used as traction motors, motors that spin targets in x-ray tubes, and low profile fan motors.

The following non-limiting example illustrates the invention.

### EXAMPLE

A rotor similar to that illustrated in FIG. 3 was fabricated. First, a pure aluminum plate was obtained and cut to the desired profile with a water jet to form a cage. Next an SMC disk was obtained and slots were machined into the disk. The slots were machined to accept the machined rotor skew. Then the aluminum cage was pressed into the mating slots in the rotor disk.

The outer radius of the obtained rotor core was 2.094 inches and the inner radius was 1 inch. The stator had 24 slots and the rotor had 30 bars. The coordinates presented in Table 1 define the skew of the rotor bars. The rotor bar skew in this example was spanned 100% of the stator pole pitch.

TABLE 1

| Theta (Degrees) | Radius (inches) |
|---|---|
| 0 | 1 |
| 1 | 1.107093 |
| 2 | 1.204704 |
| 3 | 1.294978 |
| 4 | 1.379356 |
| 5 | 1.458862 |
| 6 | 1.534254 |
| 7 | 1.60611 |
| 8 | 1.674887 |
| 9 | 1.740948 |
| 10 | 1.804593 |
| 11 | 1.866069 |
| 12 | 1.925583 |
| 13 | 1.983312 |
| 14 | 2.039407 |
| 15 | 2.094 |

The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

What is claimed is:

1. An axial flux induction motor, comprising:
a stator containing a soft magnetic composite material; and
a rotor.

2. The motor of claim 1, wherein the stator further comprises an embedded structure made from laminated ferromagnetic material.

3. The motor of claim 1, wherein slots or grooves are molded into the core of the stator to enhance flux penetration.

4. The motor of claim 1, wherein the rotor contains bars that are skewed so that the skew is substantially similar to a helical skew in a radial induction machine.

5. The motor of claim 4, wherein the bars are skewed in an angle ranging from 0% to about 200% of the stator pole pitch.

6. An axial flux induction motor, comprising:
a stator; and
a rotor containing a soft magnetic composite material.

7. The motor of claim 6, wherein the rotor further comprises an embedded structure made from laminated ferromagnetic material.

8. The motor of claim 7, wherein slots or grooves are molded into the core of the stator to enhance flux penetration.

9. The motor of claim 6, wherein the rotor contains bars that are skewed.

10. The motor of claim 9, wherein the bars are skewed so that the skew is substantially similar to a helical skew in a radial induction machine.

11. An axial flux induction motor, comprising:
a stator; and
a rotor containing bars which are skewed so that the skew is substantially similar to a helical skew in a radial induction machine.

12. The motor of claim 11, wherein the bars are skewed in an angle ranging from 0% to about 200% of the stator pole pitch.

13. The motor of claim 11, wherein the rotor comprises a soft magnetic composite material.

14. The motor of claim 11, wherein the stator comprises a soft magnetic composite material.

15. The motor of claim 11, wherein the rotor and the stator comprise a soft magnetic composite material.

16. An axial flux induction motor having an axial height less than about 3 cm.

17. The motor of claim 16, wherein the height range is about 2 cm.

18. A rotor for an axial flux induction motor, the rotor containing bars having a skew.

19. The rotor of claim 18, wherein the bars are skewed in an angle ranging from 0% to about 200% of the stator pole pitch.

20. The rotor of claim 18, wherein the bars are skewed so that the skew is substantially similar to a helical skew in a radial induction machine.

21. An electrical machine containing an axial flux induction motor having a height less than about 3 cm.

22. A method for making an axial flux induction motor, the method comprising:
providing a stator containing a soft magnetic composite material;
providing a rotor; and
combining the rotor and stator.

23. A method for making an axial flux induction motor, the method comprising:
providing a stator;
providing a rotor containing a soft magnetic composite material; and
combining the rotor and stator.

24. A method for making an axial flux induction motor, the method comprising:
providing a stator;
providing a rotor containing bars which are skewed so that the skew is substantially similar to a helical skew in a radial induction machine; and
combining the rotor and stator.

25. A method for making a stator for an axial flux induction motor, comprising:
combining a laminate material, pre-wound winding structures, and a soft magnetic composite material in a mold; and
compacting the mold to make a stator.

26. The method of claim 25, including contacting the laminate material and the soft magnetic composite material.

27. A method for making a rotor for an axial flux induction motor, comprising:
combining a laminate material and a soft magnetic composite material in a mold; and
compacting the mold to make a rotor.

28. The method of claim 27, further including forming the rotor with bars having a skew so that the skew is substantially similar to a helical skew in a radial induction machine.

29. The method of claim 28, wherein the bars are skewed in an angle from 0 percent to about 200 percent of the stator pole pitch.

30. A method for making an axial flux induction motor, comprising:
providing a stator by combining a laminate material and a soft magnetic composite material in a mold and then compacting the mold;
providing a rotor; and
combining the stator and the rotor.

31. A method for making an axial flux induction motor, comprising:
providing a stator;
providing a rotor by combining a laminate material and a soft magnetic composite material in a mold and then compacting the mold; and
combining the stator and the rotor.

32. A method for making an axial flux induction motor, comprising:
providing a stator;
providing a rotor containing bars that are skewed so that the skew is substantially similar to a helical skew in a radial induction machine; and
combining the stator and the rotor.
